(19) United States
(12) Patent Application Publication
(10) Pub. No.: US 2008/0061243 A1
(43) Pub. Date: Mar. 13, 2008

(54) Radiation detector having a fiber optic wedge with a plurality of parallel fibers

(76) Inventors: Niraj K. Doshi, Knoxville, TN (US); James Luke Corbeil, Knoxville, TN (US); Matthias J. Schmand, Lenoir City, TN (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/520,118

(22) Filed: Sep. 13, 2006

(51) Int. Cl. G01T 1/20

(52) U.S. Cl. 250/368

(57) ABSTRACT

A radiation detector having a fiber optic wedge with a plurality of parallel optical fibers is provided for yielding a more cost-effective radiation detector by reading out more scintillator elements or crystals per photodetector surface area. The fiber optic wedge provides a cost efficient method for increasing the number of scintillators that may be read out by a single position-sensitive photodetector of the radiation detector, such as a PET camera.

### BACKGROUND

1. Technical Field

The present disclosure generally relates to the field of imaging using scintillators and position sensitive photodetectors as used in conventional nuclear medicine cameras, such as positron emission tomography (PET) systems or other imaging devices requiring pixilated element readout. In particular, the present disclosure relates to a radiation detector having a fiber optic wedge with a plurality of parallel fibers.

2. Background of Related Art

Nuclear medicine is a unique medical specialty wherein radiation is used to acquire images which show the function and anatomy of organs, bones or tissues of the body. Radiopharmaceuticals are introduced into the body, either by injection or ingestion, and are attracted to specific organs, bones or tissues of interest. Such radiopharmaceuticals produce gamma photon emissions which emanate from the body and are detected by a radiation detector, such as a positron emission tomography (PET) camera.

Conventional PET cameras utilize a scintillation crystal (usually made of lutetium oxyorthosilicate (LSO) or lanthanum bromide (LaBr)) which absorbs the gamma photon emissions and emits light photons (or light events) in response to the gamma absorption. An array of photodetectors, such as photomultiplier tubes, is positioned adjacent to the scintillation crystal. The photomultiplier tubes receive the light photons from the scintillation crystal and produce electrical signals having amplitudes corresponding to the amount of light photons received. The electrical signals from the photomultiplier tubes are applied to position computing circuitry, wherein the location of the light event is determined, and the event location is then stored in a memory, from which an image of the radiation field can be displayed or printed.

FIG. 1 illustrates a PET camera detector 10 comprising an array of scintillation crystals 12. Generally, the surface area of the scintillation crystal array is large enough (10×10 cm) to image a significant part of the human body. An array of photodetectors 13, such as an array of photo-multiplier tubes (PMTs) having a plurality of PMTs 14, views the scintillation crystal array surface area, to give positional sensitivity. Each PMT 14 has an X and a Y coordinate. When a photon is absorbed by a scintillation crystal 12, light energy is generated in the form of visible light. A number of PMTs 14 receive the light via a respective light guide 16 and produce signals.

The X and Y coordinates of the event are determined by associated circuitry 18 using as a main parameter the strength of the signals generated by each PMT 14. The energy of the event is proportional to the sum of the signals, called the Z signal. Only Z signals within a given range are counted. A housing 20 surrounds the scintillation crystal array, the array of photodetectors 13 and associated circuitry 18 to minimize background radiation. As shown by FIG. 2, a glass 24 is generally placed between the scintillation crystal array and the array of photodetectors 13 to spread the light amongst the PMTs 14.

Some PET radiation detectors utilize multi-channel or position-sensitive PMTs (PS-PMTs) instead of the conventional single channel PMTs described above. PS-PMTs allow the determination of scintillator crystal interaction without having to share the light photons across several PMTs. However, PS-PMTs tend to be more expensive than conventional single channel PMTs. They also increase the number of electronics channels one may potentially need to read out the signals unless a multiplexing scheme is utilized. Also, in order to cover a large area of scintillation material, more PS-PMTs need to be used, thereby increasing the cost of a PET camera. Although, only PS-PMTs are discussed here, one skilled in the art may also be aware of other position sensitive photodetectors, such as position-sensitive avalanche photodiodes (PS-APDs) which are even smaller.

One solution in the prior art is to place at least one fiber optic taper acting as a light guide between the scintillation crystal array and the PMTs for altering the light response function of the scintillation crystals. A seemingly large taper may be used to create a larger imaging area and thus, enable a larger detection element area of the photodetector to be read out. However, this method causes the absorption of the light photons by the light absorbing taper and therefore, degrades the energy resolution of the radiation detector.

Further, the taper typically involves fused fiber optics with their concomitant loss in light collection due to index of refraction mismatches and the fact that the fiber optics are tapered violate their fiber optic principles due to lack of parallelism of the clad(s). Also, the one-for-one coupling of light guides per scintillator element or crystal can be prohibitive in manufacture and often results in poor surface matching, in terms of surface area, for light collection from the scintillator array. Additionally, the cost of a fiber optic taper becomes much more expensive as the volume/mass of the fiber optic taper increases.

A fiber optic taper generally includes a geometrical shape having two parallel surfaces and a plurality of tapered (non-parallel) fibers extending there through. The plurality of tapered fibers is typically arranged in a plurality of fiber bundles. The tapered fibers can be made from glass, plastics or other material having optical properties. An example of a fiber optic taper is shown by FIG. 3 and designated generally by reference numeral 300. As shown by FIG. 3, the radius or cross-section of the taper 300 increases from top to bottom, and the taper 300 is sliced or cut at location A to provide a flat surface 304 which is opposite flat surface 306 (it is noted that surfaces 304, 306 can be, but do not have to be parallel). A plurality of tapered fibers 308 extend between the two surfaces 304, 306. Thus, the fiber optic taper 300 is characterized as having a plurality of tapered or non-parallel fibers.

### SUMMARY

It is an aspect of the present disclosure to provide a radiation detector having a fiber optic wedge, instead of a fiber optic taper, having a plurality of un-tapered or parallel fibers for yielding a cost effective means of detector fabrication by reading out more scintillator elements or crystals per photodetector surface area at a significantly lower price.

In accordance with the above-noted aspect of the present disclosure, a radiation detector having a relatively inexpensive and easier to manufacture approach for reading out a larger area of a photodetector's detection surface is presented. Specifically, the present disclosure presents a radiation detector, such as a positron emission tomography (PET) camera, having a coherent fiber optic wedge, instead of a fiber optic taper, having a plurality of parallel or un-tapered fibers. The coherent fiber optic wedge is made from plastic, glass and/or silica fibers, or other optical materials. Several optical fibers are in optical communication with a plurality of scintillator elements or crystals of a scintillator array for enabling the read out of more scintillator crystals per area of photodetector surface in a more economical fashion.

In accordance with an embodiment of the present disclosure, the fiber optic wedge includes a plurality of parallel or un-tapered optical fibers configured to optically communicate with scintillator elements or crystals of a scintillator array. The fiber optic wedge can be pyramidal, trapezoidal or any other geometric shape or configuration suitable for enabling the read out of more scintillator crystals per area of photodetector surface in accordance with the present disclosure.

According to another embodiment of the present disclosure, a radiation detector, such as a PET camera, is presented for detecting gamma photon emissions and generating electrical energy. The radiation detector includes a position sensitive photodetector (PS-PMT) assembly and associated circuitry for detecting and converting light energy to electrical energy, a plurality of scintillation crystals positioned in proximity to the PS-PMT for detecting gamma photon emissions and generating the light energy, and a fiber optic wedge optically coupling the plurality of scintillation crystals with the PS-PMT, where the fiber optic wedge has a plurality of parallel optical fibers.

### BRIEF DESCRIPTION OF THE DRAWINGS

The disclosure will become more clearly understood from the following detailed description in connection with the accompanying drawings, in which:

FIG. 1 is a schematic illustration of a prior art radiation detector;

FIG. 2 is a schematic illustration showing gamma ray interactions with a scintillation crystal of a prior art radiation detector;

FIG. 3 is a schematic illustration of a fiber optic taper according to the prior art;

FIG. 4a is a cross-sectional, schematic illustration of a radiation detector in accordance with an embodiment of the present disclosure;

FIG. 4b is a perspective, schematic illustration of the radiation detector shown by FIG. 4b;

FIG. 5 is a perspective view of a fiber optic wedge in accordance with the present disclosure;

FIG. 6 is a schematic cross-sectional view of the fiber optic wedge shown by FIG. 5 illustrating a plurality of parallel optical fibers; and

FIGS. 7a, 7b and 7c are schematic illustrations of fiber optic wedges in accordance with the present disclosure.

### DETAILED DESCRIPTION

The following description is presented to enable one of ordinary skill in the art to make and use the disclosure and is provided in the context of a patent application and its requirements. Various modifications to the disclosed embodiments will be readily apparent to those skilled in the art and the generic principles herein may be applied to other embodiments. Thus, the present disclosure is not intended to be limited to the embodiments shown but is to be accorded the broadest scope consistent with the principles and features described herein.

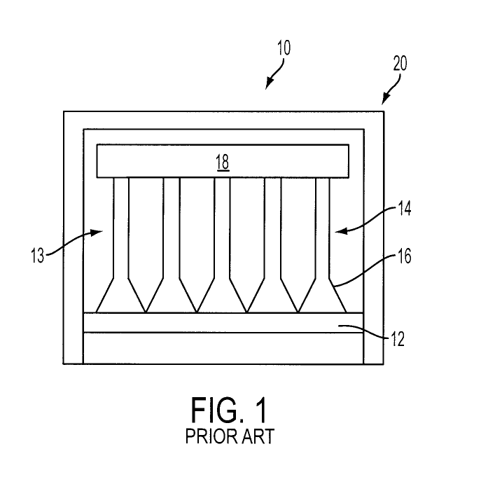

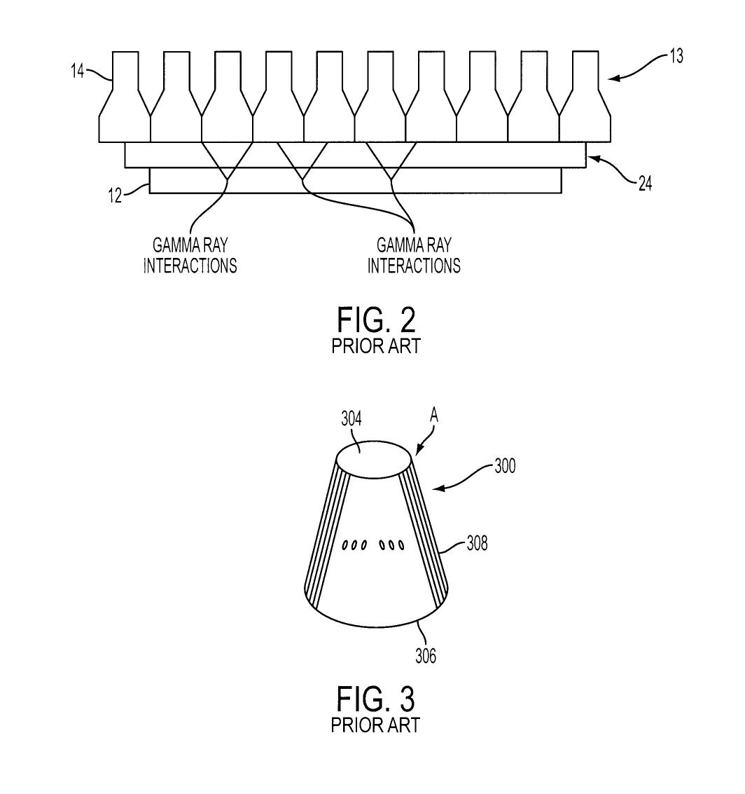

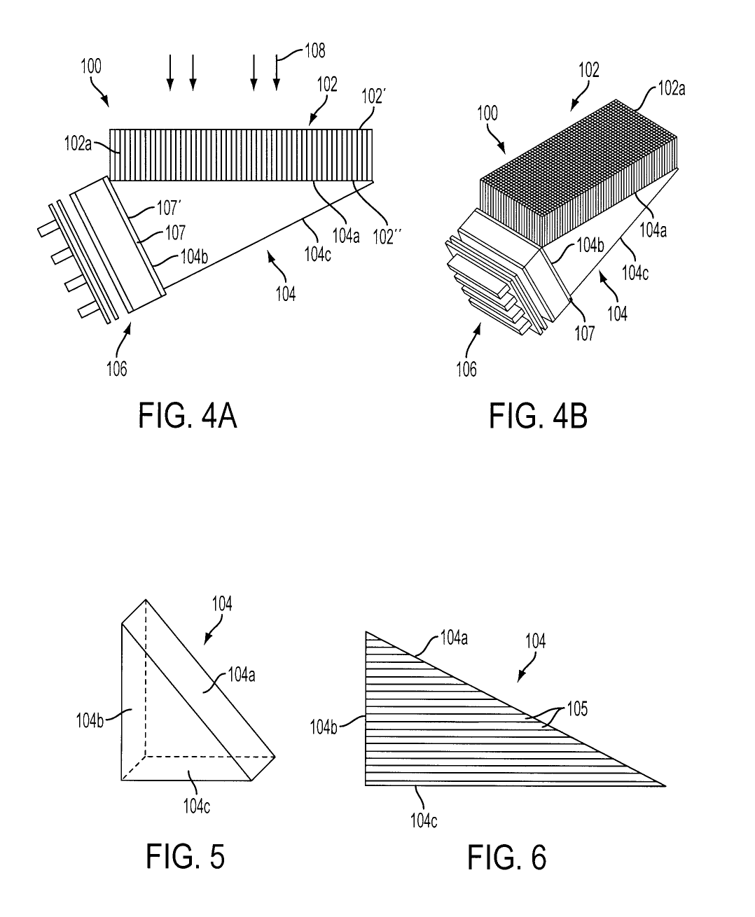

Referring now to the drawings, and initially to FIGS. 4a and 4b, there are shown cross-sectional and perspective schematic illustrations of a radiation detector in accordance with the present disclosure and generally referenced by numeral 100. The radiation detector 100 can be a positron emission tomography (PET) camera detector and includes a scintillator array 102 having a plurality of scintillator crystals or elements 102a, a coherent fiber optic wedge 104 (see FIGS. 5 and 6) having a plurality of parallel or un-tapered optical fibers 105, and a position-sensitive photodetector (PS-PMT) assembly 106 having components as known in the art (such as the components described above with reference to FIGS. 1 and 2). The fiber optic wedge 104 increases the detection surface area of the radiation detector 100 per position-sensitive photodetector assembly 106.

The fibers 105 of the optical wedge 104 are on the order of microns in diameter. Multiple bundles of these fibers 105 are heated and pressed together to form a fiber optic bundle. The fiber optic bundles are then cut to the geometrical configuration needed for the application. Because fiber optic tapers are fused, drawn out, and then cut, there is much more wasted material as compared to a fiber optic wedge in accordance with the present disclosure. Therefore, the use of the fiber optic wedge 104 in accordance with the present disclosure is cheaper than using conventional fiber optic tapers.

Thus, the benefits of using the un-tapered fiber optic wedge 104 over a fiber optic taper include relative cost efficiency of manufacturing, relative ease of manufacturing and relatively less material and labor necessary to produce the fiber optic wedge.

The scintillator array 102, as known in the art, is at least partially used for detecting and absorbing gamma photon radiation emissions 108 emanating from the body and directing the photons from one end 102′ of the array 102 to an opposite end 102″ of the array 102. Types of scintillator elements 102a that can be used in the scintillator array 102 include inorganic crystals, organic plastics, organic liquids and organic crystals. Preferably, the elements 102a of the scintillation array 102 are made from high light yield scintillators, such as lutetium oxyorthosilicate (LSO) or lanthanum bromide (LaBr).

End 102″ of the scintillator array 102 is positioned in proximity to and preferably in contact with a surface area or side 104a of the wedge 104. Another side 104b of the wedge 104 is positioned in proximity to and preferably in contact with the photodetector assembly 106 for transferring photons from the scintillator array 102 to the photodetector assembly 106. Side 104b is preferably in contact with a glass entrance window 107 of the photodetector assembly 106.

As shown by FIG. 6, the fiber optic wedge 104 includes a plurality of glass, plastic and/or silica optical fibers 105. The fibers 105 can also be made from other optical materials, besides glass, plastic and silica. The fibers 105 transfer light photons from one side 104a to side 104b of the wedge 104. A group of fibers 105 can be bundled together to form a fiber bundle, such that the fiber optic wedge 104 includes a plurality of fiber bundles packed together to form the particular geometrical configuration of the wedge 104.

When the wedge 104 is positioned in the radiation detector 100 as shown by FIGS. 4a and 4b, a number of optical fibers 105 are optically coupled to a scintillator crystal 102a for enabling the read out of the scintillation light. In particular, during operation of the radiation detector 100, gamma photon radiation emissions 108 propagate through the scintillator crystals 102a before interacting in the scintillator crystals 102a which, thereafter, produce light photons. The light photons are then directed to the photodetector assembly 106 either directly or via reflection via an inner surface 104b of the wedge 104a.

In the embodiment illustrated by FIGS. 4a and 4b, the fiber optic wedge 104 allows the detection of the scintillator array 102 that is two times the active surface area 107′ of the photodetector assembly 106. One skilled in the art can realize that the wedge 104 may be cut at different angles in order to increase or decrease the amount of exposed surface area for reading out detection elements 102a.

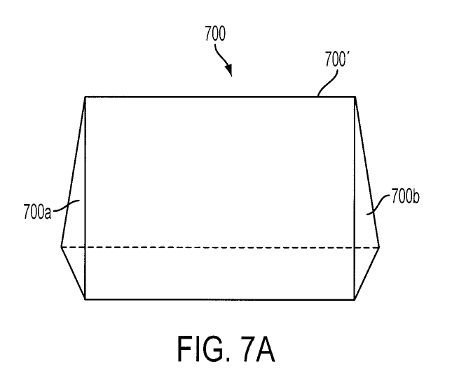

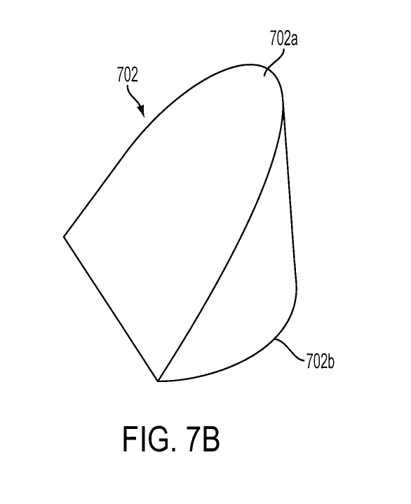

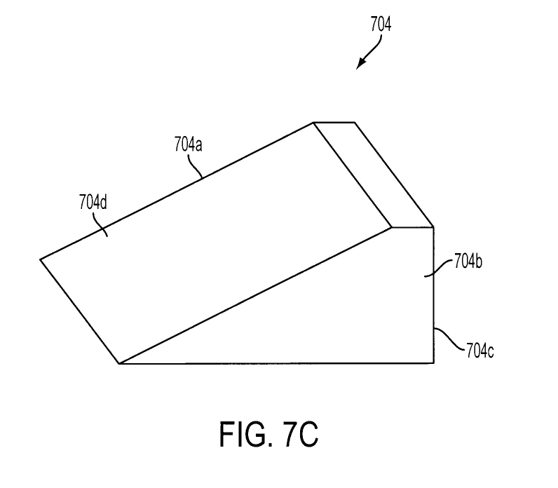

The fiber optic wedge 104 as shown by FIGS. 4a, 4b, 5 and 6 is pyramidal having three rectangular faces or sides 104a, 104b, 104c and two triangular faces or sides. Other geometrical shapes or configurations for the fiber optic wedge are envisioned, such as trapezoidal as mentioned above and shown by FIG. 7c, in accordance with the present disclosure which can be substituted for the wedge 104 in FIGS. 4a and 4b.

Regardless of the geometrical configuration, the wedges according to the present disclosure have a plurality of parallel optical fibers for use in a radiation detector as shown by FIGS. 4a and 4b. The wedges shown by FIGS. 7a, 7b and 7c and designated generally by reference numerals 700, 702 and 704 can be provided in a radiation detector according to the present disclosure. These wedges include a wedge 700 having a top edge 700′ and two parallel end triangles 700a, 700b (the fibers (not shown) run horizontally from one end triangle 700a to the other end triangle 700b); a cylinder-based wedge 702 cut from a cylinder by slicing the cylinder with a plane that intersects the base of the cylinder (the fibers (not shown) run vertically from an oblique surface 702a to a flat surface 702b); and a wedge 704 having a trapezoidal geometric configuration with two parallel end trapezoids 704a, 704b (the fibers (not shown) run horizontally from side 704c to the opposite side 704d). FIG. 7c illustrates the wedge 704 having a plurality of parallel fibers 705.

Although the present disclosure has been described in accordance with the embodiments shown, one of ordinary skill in the art will readily recognize that there could be variations to the embodiment and these variations would be within the spirit and scope of the present disclosure. Accordingly, many modifications may be made by one of ordinary skill in the art without departing from the spirit and scope of the appended claims.

1. A radiation detector comprising:
a scintillator array having a plurality of scintillator elements;
a fiber optic wedge having a plurality of parallel fibers and defining a plurality of sides, a first side of said plurality of sides being positioned in proximity to the scintillator array; and
a photodetector assembly positioned in proximity to a second side of the plurality of sides of the fiber optic wedge, wherein the fiber optic wedge provides for detection of a surface area of the scintillator array that is larger than an area of the photodector assembly.

2. The radiation detector according to claim 1, wherein the scintillator array is manufactured from materials selected from the group consisting of inorganic crystals, organic plastics, organic liquids and organic crystals.

3. The radiation detector according to claim 1, wherein the geometric configuration of the fiber optic wedge is selected from the group consisting of pyramidal, trapezoidal and cylinder-based geometric configurations.

4. The radiation detector according to claim 1, wherein the fiber optic wedge is manufactured from materials selected from the group consisting of plastic, glass and silica.

5. The radiation detector according to claim 1, wherein the scintillation array is made from one of lutetium oxyorthosilicate (LSO) or lanthanum bromide (LaBr).

6. The radiation detector according to claim 1, wherein the plurality of parallel fibers of the fiber optic wedge are configured for transferring photons from the first side to the second side.

7. The radiation detector according to claim 6, wherein the plurality of parallel fibers of the fiber optic wedge are manufactured from materials selected from the group consisting of plastic, glass and silica.

8. The radiation detector according to claim 1, wherein the second side of the plurality sides of the fiber optic wedge contacts a glass of the photodetector assembly.

9. The radiation detector according to claim 1, wherein the plurality of sides of the fiber optic wedge are rectangular.

10. A fiber optic wedge for a radiation detector, said fiber optic wedge comprising:
a plurality of sides; and
a plurality of parallel fibers optically communicating a first side of the plurality of sides with a second side of the plurality of sides, wherein the fiber optic wedge provides for detection of a surface area of a scintillator array that is larger than an area of a photodector assembly.

11. The fiber optic wedge according to claim 10, wherein the first side of the fiber optic wedge is positioned in proximity to a scintillator array of the radiation detector.

12. The fiber optic wedge according to claim 11, wherein the scintillator array is manufactured from materials selected from the group consisting of inorganic crystals, organic plastics, organic liquids and organic crystals.

13. The fiber optic wedge according to claim 10, wherein the geometrical configuration of the fiber optic wedge is selected from the group consisting of pyramidal, trapezoidal and cylinder-based geometrical configurations.

14. The fiber optic wedge according to claim 10, wherein the fiber optic wedge is manufactured from materials selected from the group consisting of plastic, glass and silica.

15. The fiber optic wedge according to claim 12, wherein the scintillation array is made from one of lutetium oxyorthosilicate (LSO) or lanthanum bromide (LaBr).

16. The fiber optic wedge according to claim 10, wherein the plurality of parallel fibers are manufactured from materials selected from the group consisting of plastic, glass and silica.

17. The fiber optic wedge according to claim 10, wherein the second side is positioned in proximity to a glass of a photodetector assembly of the radiation detector.

18. The fiber optic wedge according to claim 10, wherein the plurality of sides of the fiber optic wedge are rectangular.

19. A radiation detector comprising:
a scintillator array having a plurality of scintillator elements;
a fiber optic wedge having a plurality of sides and a plurality of parallel fibers optically communicating a first side of the plurality of sides with a second side of the plurality of sides, the first side of said plurality of sides being positioned in proximity to the scintillator array; and
a photodetector assembly positioned in proximity to the second side of the plurality of sides of the fiber optic wedge, wherein the fiber wedge provides for detection of a surface area of the scintillator array that is larger than an area of the photodector assembly.

20. The radiation detector according to claim 19, wherein the geometrical configuration of the fiber optic wedge is selected from the group consisting of pyramidal, trapezoidal and cylinder-based geometrical configurations.
